(19) United States
(12) Patent Application Publication
(10) Pub. No.: US 2021/0367753 A1
(43) Pub. Date: Nov. 25, 2021

(54) TRUSTED MEASUREMENT AND CONTROL NETWORK AUTHENTICATION METHOD BASED ON DOUBLE CRYPTOGRAPHIC VALUES AND CHAOTIC ENCRYPTION

(71) Applicant: SHENYANG INSTITUTE OF AUTOMATION, CHINESE ACADEMY OF SCIENCES, Liaoning (CN)

(72) Inventors: Wenli SHANG, Liaoning (CN); Peng ZENG, Liaoning (CN); Long YIN, Liaoning (CN); Chunyu CHEN, Liaoning (CN); Jianming ZHAO, Liaoning (CN); Xianda LIU, Liaoning (CN); Guoyu TONG, Liaoning (CN)

(73) Assignee: SHENYANG INSTITUTE OF AUTOMATION, CHINESE ACADEMY OF SCIENCES, Liaoning (CN)

(21) Appl. No.: 16/636,727

(22) PCT Filed: Feb. 21, 2019
(86) PCT No.: PCT/CN2019/075661

§ 371 Date: Feb. 5, 2020

(30) Foreign Application Priority Data
Nov. 2, 2018 (CN) 201811299442.5

(51) Int. Cl. H04L 9/00; H04L 9/08; H04L 9/06; H04L 9/32; G06F 21/64; H04L 9/30

(52) U.S. Cl. CPC H04L 9/001; H04L 9/0877; H04L 9/0643; H04L 9/0825; H04L 2209/127; G06F 21/645; H04L 9/30; H04L 9/0869; H04L 9/321; H04L 9/3247

(57) ABSTRACT

The present invention relates to a trusted measurement and control network authentication method based on double cryptographic values and chaotic encryption. The specific method comprises realizing identity authentication and key negotiation processes through double cryptographic values and chaotic public key ciphers and realizing secure transmission and verification of user identity credentials on the basis of building a trust chain through trusted computation for realizing a secure and trusted operating environment, thereby building a secure and trusted data transmission channel. The identity authentication method in the present invention comprises multiple links such as secure generation of user identity identifiers, read protection encapsulation, secure transmission and key negotiation. Each link adopts a unique and confidential cryptographic function for secure data generation, thereby ensuring the security of the authentication device access in an industrial measurement and control network.

### TECHNICAL FIELD

The present invention relates to a technical method of identity authentication by using double cryptographic values and a chaotic encryption key negotiation algorithm in an industrial measurement and control network, and belongs to the field of security of the industrial control network.

### BACKGROUND

With the gradual acceleration of industrial informationization degree of China, more and more communication technologies and embedded applications are applied to industrial production networks. While the convenience generated by the high and new technology for the production process is enjoyed, the information security problem of different degrees is also reflected. Once some uncontrolled devices are connected to an industrial measurement and control network, a core device of a production system may be attacked through, for example, denial of service attack or penetration mining of communication protocols; the application configuration or firmware information of the device is changed to obtain a highest control authority of the system; and then, the operating state of the entire system may be in uncontrollable risks. Therefore, to solve the problem that the traditional industrial control network lacks of an authentication technical system, an identity authentication technology needs to be integrated into the existing industrial measurement and control network to achieve secure connection of trusted authentication nodes.

Most of the current industrial measurement and control systems use a PKI-based authentication system to realize identity authentication and access permission control. The traditional USBKey-based PKI identity authentication method has the characteristics of long key, dynamic change of identity authentication credential, high security and convenient use. However, complex digital credential issuance and long credential verification structure often exist in the application scenarios of the industrial measurement and control systems, which limit the actual verification efficiency. Moreover, various embedded terminal devices in the application scenarios of the industrial measurement and control systems have limited computing capability and limited computing resources, and it is difficult to quickly and efficiently perform cryptographic operation involving multiple rounds of iteration. Therefore, a set of identity authentication and key negotiation technology theories that can resist multiple types of password attacks while having little computation overhead are needed, so as to ensure that the industrial measurement and control system networks achieve trusted work, improve the efficiency of identity authentication, and support the needs of scalable system architectures.

In conclusion, the purpose of the present invention is to design a method suitable for identity authentication between terminal devices in the industrial measurement and control network by using a technical solution for generation and verification of user identity information credential based on an idea of double cryptographic values through a key negotiation protocol based on Chebyshev mapping chaotic public key cryptography. A trusted computing technology is used to establish a trust chain, which ensures that the identity of the terminal device is trusted and also provides integrity enhancement and verification of upper layer software, to prevent the measurement and control commands and results from being untrusted due to abnormal modification of a control software module, thereby affecting the overall credibility and security level of the measurement and control system.

### SUMMARY

In view of the above technical defects, the purpose of the present invention is to provide an identity authentication method based on a combination of double cryptographic values and a chaotic encryption algorithm. The present invention negotiates a crucial key by a chaotic encryption public key cryptographic algorithm by taking the industrial measurement and control system network as an application scenario, ensures that intermediate data is difficult to be tampered through replaying or counterfeiting to avoid affecting the authentication result, and builds a security protection system of the measurement and control network information based on the trusted computing technology.

A technical solution adopted in the present invention to solve the technical problem is as follows: a trusted measurement and control network authentication method based on double cryptographic values and chaotic encryption comprises the following steps:

a control terminal and a measurement-control application server perform consistency analysis to verify the integrity of control terminal software;

the control terminal and the measurement-control application server respectively generate user identifier information by using a user cryptographic value and a measurement-control application server cryptographic value, and transmit the information by asymmetric encryption;

the control terminal generates a user identity credential; and

the measurement-control application server deduces the authenticity of the user identifier information held by a user by analyzing the user identity credential.

The step that a control terminal and a measurement-control application server perform consistency analysis to verify the integrity of control terminal software comprises the following steps:

2a) the terminal device enables the control terminal software module to execute according to a reserved order in a mode of firstly verifying and then jumping, to enhance the integrity of the control terminal software;

2b) a software module code M is transmitted to TPM in the control terminal; SHA-1 engine in the TPM computes a code digital fingerprint PCR of the software module and stores the code digit fingerprint PCR into a platform configuration register by hash extension, i.e., PCRᵢ=SHA-1(PCRᵢ∥Pᵢ), to produce an integrity representation log SML; i indicates a digital fingerprint number and SHA-1 indicates a one-way hash function;

2c) the measurement-control application server transmits a challenge string Challenge=Nonce to start integrity verification; the control terminal signs the PCR and Nonce with a private key AIK_SK of the control terminal for an internal platform configuration register, and forms a response message Response=Sign_{AIK_SK}{P CR,Nonce}∥SML with SML; Sign_{AIK_SK} indicates that the private key AIK_SK is used for digital signature operation;

2d) the measurement-control application server verifies the digital signature by using a control terminal public key AIK_PK, compares an obtained PCR integrity representative value, i.e., digital fingerprint PCR, with a PCR integrity representative value acquired by the integrity representation log SML, and verifies the integrity of the control terminal software: if consistent, integrity verification is successful; otherwise, verification fails.

The step that the control terminal and the measurement-control application server respectively generate user identifier information by using a user cryptographic value and a measurement-control application server cryptographic value, and transmit the information by asymmetric encryption comprises the following steps:

3a) the measurement-control application server generates user identity identification code F=[h(ID∥x)·h(PW∥UPK)^{β(κ)}]mod p by using a server cryptographic value K, a secret function β(·), an ID number provided by a user, a user public key UPK and a hash value of a user cryptographic value PW; h(·) indicates a one-way hash function; x indicates that the measurement-control application server holds a secret value that represents the identity; mod indicates modulo division;

3b) read protection encapsulation is conducted on the user identity identification code F through h(PW∥UPK) to obtain E(F):

E(F)=F⊕h(PW∥UPK)

3c) user identifier information {ID, C, h(PW∥UPK), E(F), EK, p, UN, AN, UC, . . . } composed of an encrypted and encapsulated user identity identification code E(F), a user ID, an encrypted and encapsulated identity authentication key EK, h(PW∥UPK), parameter p, user name UN, an area name AN and a user class UC is encrypted by using a public key UPK, and transmitted to USBKey device; USBKey adopts a private key SPK opposite to the UPK for decryption and saving; USBKey is transmitted and imported for the user identifier information through asymmetric encryption to create a secure channel.

The step that the control terminal generates a user identity credential comprises the following steps:

4a) the terminal device computes an extraction parameter h(PW∥UPK) of the user cryptographic value, de-encapsulates E(F) and restores F by computing F=E(F)⊕h(PW∥UPK), and conducts transformation through an identity authentication key K=β(h(x)^{h(ID)} mod p) between the USBKey and the measurement-control application server to obtain a user identity identification code V₁=F^{h(K)} mod p; h(·) indicates a one-way hash function; mod indicates modulo division; β(·) indicates a secret function; p indicates a parameter;

4b) a user random number R₁ acts on V₁ to obtain a dynamic change user identity credential V₂:

V₂=R₁^{h(V}^{₂}^{∥K)} mod p

4c) a time mark T₁ is used for converting and generating a user identity credential of timeliness;

(Q₁, Q₂, Q₃)=(V₁⊕h(K|T₁), R₁⊕h(K|T₁),{F6}h(|V₁)); K indicates a server cryptographic value;

d) a user identity authentication request {ID, Q₁, Q₂, Q₃, T₁} is finally produced, and transmitted to the measurement-control application server through a network.

The step that the measurement-control application server deduces the authenticity of the user identifier information held by a user by analyzing the user identity credential comprises the following steps:

5a) after receiving the identity authentication request {ID, Q₁, Q₂, Q₃, T₁} transmitted by the terminal device, the measurement-control application server firstly inspects the timeliness: if T−T₁≤threshold ΔT is satisfied, the identity authentication key K=β(h(x)^{h(ID)} mod p) shared with the USBKey is computed through the cryptographic value K, the secret function β(·) and the ID number provided by the user;

5b) next, the random number R₁=Q₂⊕h(K∥T₁) is decoupled from Q₂ by using K and T₁; the user identity identification code V₁=Q₁⊕h(K∥T₂) is restored from Q₁; a random user identity credential V₂=R₁^{h(V}^{₁}^{∥K)} mod p and a user identity credential \hat{Q}₃=h(V₁∥T₁) with the time mark are computed through R₁, V₁ and K;

5c) then, the identity credential \hat{Q}₃ obtained by restoring of the measurement-control application server is compared with the received identity credential Q₃; the user identification code V₁ and an expected user identity identification code PF=F^{h(K)} mod p are restored; consistence between V₁ and PF indicates that the user masters the cryptographic value PW, the USBKey provided by a terminal user has the cryptographic values E(F) and EK representing the users, and the user identity of the terminal device is confirmed.

The trusted measurement and control network authentication method based on double cryptographic values and chaotic encryption further comprises confirming an authentication result, which comprises the following steps:

6a) the measurement-control application server creates an identity verification result parameter AUTH∈{True,False}, generates a random number R₂ and authentication time T₂ and computes a response message parameter:

(P₁,P₂,P₃,P₄)=(R₂⊕h(V₂∥T₂),R₂^{V}^{₂}=mod p,h(P₂|T₂),AUTH⊕h(K|R₂));

6b) the measurement-control application server creates an identity authentication confirmation message {P₁, P₃, T₂,AUTH}, feeds back the message to the USBKey and also creates a session key Skey=h(K, V₂, P₂, R₁, R₂, T₁, T₂) with the terminal device;

6c) after receiving the confirmation message, the USBKey device inspects the timeliness of the time mark T₂: recomputes the parameter R₂=P₁ ⊕h(V₂∥T₂), P₂=R₂^{V}^{₂} mod p, \hat{P}₃=h(P₂∥T₂) and compares the parameter with P₃ in the confirmation message; \hat{P}₃=P₃ indicates that the measurement-control application server holds the secret value x and cryptographic function β(·) that represent the identity, can compute the identity authentication key K of the user, and can decouple identity evidence V₂ from the identity authentication request message; an identity authentication decoupling result AUTH=P₄ ⊕h(K|R₂) is reliable; the session key is computed according to 6b).

Two measurement and control terminal devices with confirmed valid user identity credentials (Q₁, Q₂, Q₃) after identity authentication conduct communication key negotiation by using a chaotic public key cryptographic algorithm, which comprises the following steps:

a) the terminal device A firstly selects a large integer r, a large prime number N and x on a finite field, and computes Tᵣ(x); and connects an own user identity identifier ID_{A}, a recipient device identity identifier ID_{B}, x, N and Tᵣ(x), encrypts with a shared session key created between the terminal device A and the measurement-control application server, generates a ciphertext E_{TA}(ID_{A}, ID_{B}, x, N, Tᵣ(x)) and then transmits the ciphertext to the measurement-control application server, r and N are larger than set values;

b) after receiving the information transmitted by the terminal device A, the measurement-control application server decrypts the data E_{TA}(ID_{A}, ID_{B}, x, N, Tᵣ(x)) by using a key shared with the terminal device A to verify whether the device A is a legal identity; if verification fails, the decryption is stopped; otherwise, the obtained information is encrypted by using the key shared with the terminal device B to obtain E_{TB}(ID_{B}, ID_{A}, x, N, Tᵣ(x)); and E_{TB}(ID_{B}, ID_{A}, x, N, Tᵣ(x)) is transmitted to the terminal device B;

c) after receiving the information, the terminal device B decrypts E_{TB}(ID_{B}, ID_{A}, x, N, Tᵣ(x)) by using the key shared with the measurement-control application server, and then randomly selects a large integer s for computing Tₛ(x); the identity identifiers ID_{B} and Tₛ(x) of the terminal device B are connected and encrypted with the key shared with the measurement-control application server, i.e., E_{TB}(ID_{B}, Tₛ(x)); then, k=Tₛ(Tᵣ(x)) is computed, and a message confirmation code MAC_{B}=hₖ(ID_{B}, ID_{A}, Tᵣ(x)) is computed through Hash function by using k as a key; the terminal device B transmits E_{TB}(B, Tₛ(x)) and MAC_{B} to the measurement-control application server; s is larger than a set value; hₖ indicates the Hash function; Tₛ(x) and Tᵣ(x) indicate computation expressions of the chaotic public key cryptographic algorithm;

d) after receiving the information transmitted by the terminal device B, the measurement-control application server decrypts E_{TB}(ID_{B},Tₛ(x)) by using a key shared with the device B and verifies the identity of the device B; if verification fails, decryption is stopped; otherwise, the measurement-control application server encrypts ID_{B} and Tₛ(x) by using a key shared with the device A, i.e., E_{TA}(ID_{B},Tₛ(x)); then, E_{TA}(ID_{B},Tₛ(x)) and MAC_{B} are transmitted to the terminal device A;

e) after receiving the information transmitted by the measurement-control application server, the terminal device A computes a message confirmation code MAC′_{B}=hₖ(ID_{B},ID_{A},Tᵣ(x)) and compares whether MAC′_{B} is equal to MAC_{B}; if not, the device A stops negotiation communication with B; otherwise, the device A confirms that B is a true communication object and a session key shared by terminal devices A and B is k=Tₛ(Tᵣ(x)); the terminal device A transmits an authentication result message MAC_{A}=hₖ(ID_{A}, ID_{B},Tₛ(x)) to the terminal device B for confirmation;

f) the terminal device B computes a Hash function value MAC′_{A}=hₖ(ID_{A},ID_{B},Tₛ(x)) by using a key k, and compares whether MAC′_{A} is equal to received MAC_{A}; if not, the terminal device B stops negotiation; otherwise, the terminal device A is confirmed as a true communication object; and a session key is k.

The present invention has the following beneficial effects and advantages:

1. The present invention computes derivable user identity identification code V₁ through parameters [symbol] and K and a one-way function h by using a double-cryptographic value solution, uses the random number R₁ for V₁ and K to form the dynamically changing user identity credential V₂, and introduces the time mark T₁ to form identity credentials Q₁, Q₂ and Q₃ of timeliness for transmission on the Internet. If a user identity is counterfeited, K, V₁ and V₂ need to be obtained by analyzing Q₁, Q₂ and Q₃. Because Q₁ and Q₂ are obtained by XOR operation of two position parameters, the user identity can only be cracked by a random guessing method and the probability of cracking success is computed as 12¹⁶⁰⁺ⁿ^{_{T}}. T represents the time taken to crack by the random guessing method, and n represents the number of failures before the last attack guess is successful. Compared with the traditional PKI solution, a double-cryptographic value identity authentication solution has stronger identity counterfeit resistant capability.

2. Compared with the traditional PKI solution-based identity authentication solution, the present invention has less performance overhead in the complexity of the involved cryptographic operation. In the process of user digital credential verification and private key credential verification involved in the PKI solution-based user authentication process, from the root CA, the user digital credential with a credential chain length of n level needs an authenticator to perform n times of credential verification to verify whether the digital signature of a credential issuer is valid. Each operation involves at least 1 large integer modular exponentiation and 1 hash operation, and the total overhead is ne+nh, wherein e is the time overhead of the large integer modular exponentiation, and h is the time overhead of the hash operation. The verification of the user private key credential needs to send challenge information and response information to the USB Key once, at least 2 times of encryption operation, 2 times of signature computing and 1 signature verifying computing. The computation overhead is 5e+3h, and the total computation overhead is (n+5)e+(n+3)h. In the present invention, the authenticator needs 2 times of hash operation and 2 times of modular power operation when computing K, R₂, V₁, V₂ and \hat{Q}₃, and needs 3 times of hash operation and 1 modular power operation when computing response message parameters P₁, P₂, P₃ and P₄. The total computation overhead is 5e+3h. Therefore, the longer the credential chain is, the better the advantages of the present invention can be reflected.

3. The present invention well applies its characteristics such as chaotic characteristic, semigroup characteristic and unidirectivity to the process of inter-device identity authentication and key negotiation by using Chebyshev-based mapping chaotic public key cryptographic algorithm. The present invention adopts encrypted transmission for the sensitive parameter Tₛ(x) and the device user identity identifiers ID_{A} and ID_{B} required by possibly generating short-cycle attacks, which is difficult for the attacker to brack by a short-cycle attack mode. Moreover, a trusted third-party measurement-control application server is introduced and is responsible for encrypted data transmission; the Hash function is used to generate a confirmation code to ensure that any change of the information can be detected, so as to prevent middlemen from monitoring the attack. In the key negotiation process of the present invention, large integers r and s are randomly generated each time. Only devices A and B can determine the generation mode of session key k and the random elements in Hash authentication code to ensure the timeliness of the verification information, thereby effectively resisting replay attacks.

### DESCRIPTION OF DRAWINGS

FIG. 1 is a schematic diagram of a software integrity enhancing and verifying method of a control terminal of a trusted measurement and control network authentication technology in the present invention;

FIG. 2 is a schematic diagram of a secure generation method of user identity identifier information in an identity authentication stage of a trusted measurement and control network in the present invention;

FIG. 3 is a schematic diagram of a user identity credential generating process in an identity authentication stage of a trusted measurement and control network in the present invention;

FIG. 4 is a schematic diagram of a user identity verifying process in an identity authentication stage of a trusted measurement and control network in the present invention;

FIG. 5 is a schematic diagram of an inter-device key negotiation process in an identity authentication stage of a trusted measurement and control network in the present invention; and

FIG. 6 is a schematic diagram of an authentication method of a trusted measurement and control network in the present invention.

### DETAILED DESCRIPTION

The present invention will be further described in detail below in combination with the drawings and the embodiments.

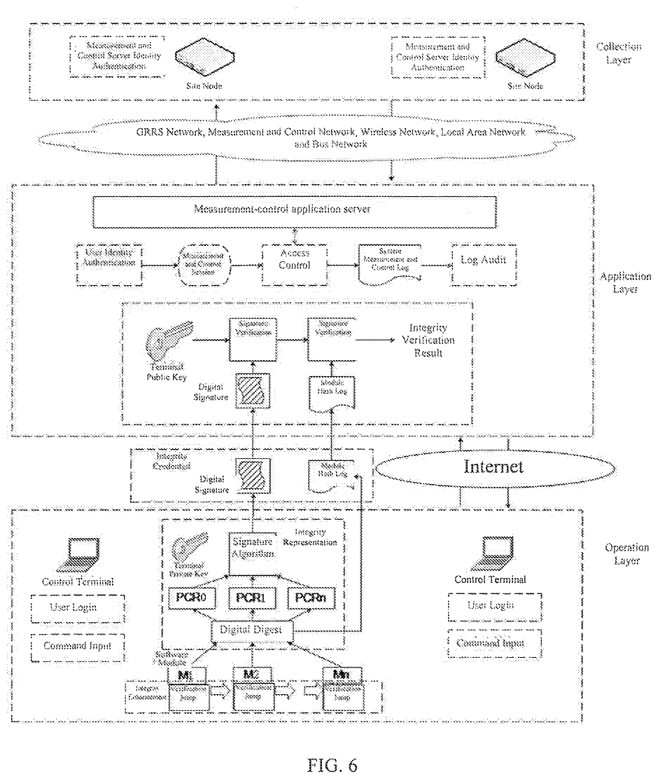

As shown in FIG. 6, the present invention relates to a trusted measurement and control network authentication technical method based on double cryptographic values and a chaotic encryption algorithm. The specific method comprises realizing identity authentication and key negotiation processes through double cryptographic values and chaotic public key ciphers and realizing secure transmission and verification of user identity credentials on the basis of building a trust chain through trusted computation for realizing a secure and trusted operating environment, thereby building a secure and trusted data transmission channel. The identity authentication method in the present invention comprises multiple links such as secure generation of user identity identifiers, read protection encapsulation, secure transmission and key negotiation. Each link adopts a unique and confidential cryptographic function for secure data generation, thereby ensuring the security of the authentication device access in an industrial measurement and control network.

TPM is an abbreviation of a trust platform module, exists for providing a trusted root for the platform in the beginning of establishment of a trust computing chain, and usually refers to a TPM chip.

SHA-1 engine is an algorithm engine that executes SHA-1 one-way hash function and exists as a cryptographic operation module in the TPM chip.

1. Integrity Enhancement and Verification of Software of an Operation Terminal

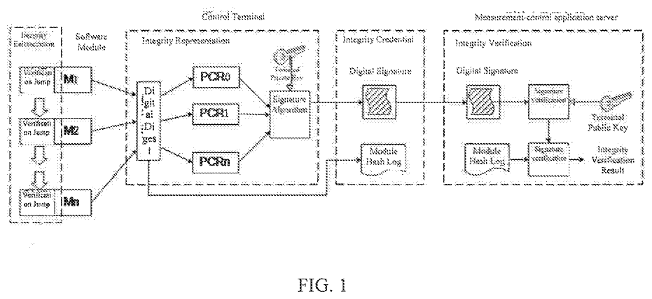

As shown in FIG. 1, the operation terminal transmits module digital fingerprints and integrity representation logs collected in a trust chain transmission process to a measurement-control application server based on a trusted computing digital signature method. The application server verifies the software integrity of the measurement and control terminal by performing consistency analysis on non-counterfeit digital fingerprints and the integrity logs. The integrity enhancement and verification process comprises the following relevant steps:

a) The terminal device enables a control terminal software module to execute according to a reserved order in a mode of firstly verifying and then jumping by using a TPM-based trust chain transmission method, to enhance the software integrity of the control terminal.

b) A software module code M is simultaneously transmitted to TPM; SHA-1 engine computes a code digital fingerprint of the module and stores the code digit fingerprint into a platform configuration register by hash extension, i.e., PCRᵢ=SHA-1(PCRᵢ∥Pᵢ), to produce an integrity representation log SML.

c) A monitoring module of a control terminal of the measurement-control application server transmits a challenge string Challenge=Nonce to start integrity verification; the control terminal signs the PCR and Nonce with a private key AIK_SK of the control terminal for the PCR register, and forms a response message Response=Sign_{AIK_SK}{PCR, Nonce}∥SML with SML.

d) The measurement-control application server verifies the digital signature by using a control terminal public key AIK_PK, compares a PCR integrity representative value with an integrity representative value log SML, and verifies the software integrity of the control terminal.

2. Secure Generation of User Identity Identifier Information

The user identity identifier information of the measurement and control terminal device must have security characteristics such as uniqueness and anti-guessing, and is transmitted and imported into a tamper-proof security storage medium such as USBKey through a secure channel by using the read encapsulation technology; and only a designated user can hold the information.

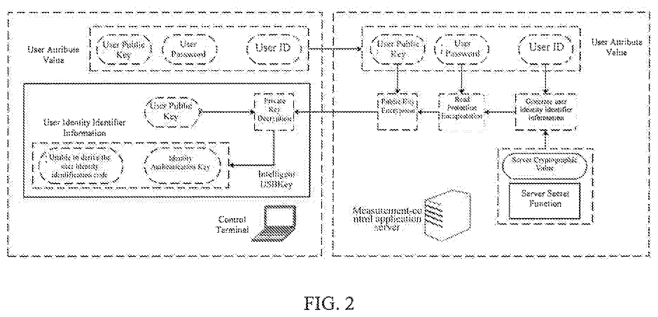

As shown in FIG. 2, a secure generation method of user identity identifier information in the identity authentication process based on an idea of double cryptographic values comprises three aspects of user identity identification code generation, read protection encapsulation and user identity identifier information security transmission. The realization process of each stage is as follows:

a) Generation Method of User Identification Code Having Uniqueness and Anti-Guessing

The measurement and control system application server generates underivable user identity identification code F=[h(ID∥x)·h(PW∥UPK)^{β(κ)}]mod p by using a server cryptographic value κ, a secret function β(·), an ID number provided by a user, a user public key UPK and a hash value of a user cryptographic value PW, thereby completing the generation of the user identification code.

b) Read Protection Encapsulation Algorithm of User Identity Identification Code

Read protection encapsulation is conducted on the user identity identification code F through h(PW∥UPK) to obtain E(F):

E(F)=F⊕h(PW∥UPK)

F can be restored from the USBKey only when the user inputs a correct cryptographic value PW, to continue an identity authentication request process.

c) Secure Transmission and Import of User Identity Identifier Information

The measurement-control application server encrypts user identifier information {ID, C, h(PW∥UPK), E(F), EK, p, UN, AN, UC, . . . } composed of an encrypted and encapsulated user identity identification code E(F), a user ID, an encrypted and encapsulated identity authentication key EK, h(PW∥UPK), parameter p, user name UN, an area name AN and a user class UC by using a public key UPK, and transmitted to USBKey device; USBKey adopts a private key SPK opposite to the UPK for decryption and saving; USBKey is transmitted and imported for the user identifier information through an asymmetric encryption technology to create a secure channel.

3. Generation of a User Identity Credential

The user identity credential of the measurement and control terminal device comprises user identification feature codes which shall have security characteristics such as dynamics, timeliness, anti-eavesdropping, recording and replay.

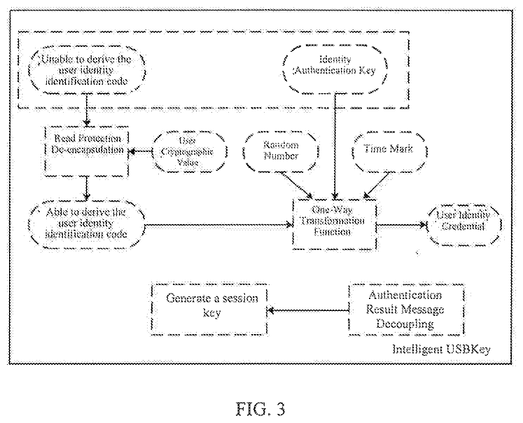

As shown in FIG. 3, the user identity credential is generated in USBKey; and the process is activated when the user inputs a correct PIN password or user cryptographic value PW.

Generation of the user identity credential comprises the following steps:

a) an extraction parameter h(PW∥UPK) of the user cryptographic value is computed; E(F) is de-encapsulated and F is restored by computing F=E(F)⊕h(PW∥UPK); and transformation is conducted through an identity authentication key K=β(h(x)^{h(ID)} mod p) between the USBKey and the measurement-control application server to compute a user identity identification code V₁=F^{h(K)} mod p.

b) A user random number R₁ acts on V₁ to obtain a dynamic change user identity credential V₂:

V₂=R₁^{h(V}^{₁}^{∥K)} mod p

c) A time mark T₁ is used for converting and generating a user identity credential of timeliness:

(Q₁,Q₂,Q₃)=(V₁⊕h(K|T₁),R₁⊕h(K|T₁),{F6}h(|V₁))

d) A user identity authentication-request {ID, Q₁, Q₂, Q₃, T₁} is finally produced, and transmitted to the measurement-control application server through a network.

4. Verification of the User Identity Credential

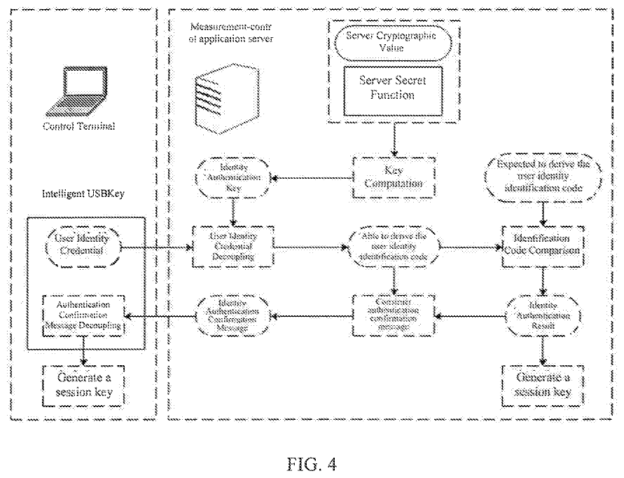

As shown in FIG. 4, after receiving the identity authentication request transmitted by the terminal device, the measurement-control application server decouples the identity authentication request through the user identity credential to obtain derivable user identity identification codes, and then compares the codes with expected user identity identification codes to finally obtain an identity authentication result. The verification process of the user identity credential comprises the following steps:

a) When the user identity credential is verified, after receiving the identity authentication request {ID, Q₁, Q₂, Q₃, T₁} transmitted by the terminal device, the trusted measurement-control application server firstly inspects the timeliness: if T−T₁≤ΔT is satisfied, the identity authentication key K=β(h(x)^{h(ID)} mod p) shared with the USBKey is computed through the cryptographic value κ, the secret function β(·) and the ID number provided by the user.

b) Next, the random number R₁=Q₂ ⊕h(K∥T₁) is decoupled from Q₂ by using K and T₁; the derivable user identity identification code V₁=Q₁ ⊕h(K∥T₁) is restored from Q₁; a random user identity credential V₂=R₁^{h(V}^{₁}^{∥K)} mod p and a user identity credential \hat{Q}₃=h(V₁∥T₁) with the time mark are computed through R₁, V₁ and K.“Derivable” means that Q₁ can be obtained by computing Q₁ ⊕h(K∥T₁), i.e., Q₁ can be derived by computing Q₁ ⊕h(K∥T₁).

c) Then, the identity credential \hat{Q}₃ obtained by restoring of the measurement-control application server is compared with the received identity credential Q₃; the derivable user identification code V₁ and an expected derivable user identity identification code PF=F^{h(K)} mod p are restored; consistence indicates that the user masters the cryptographic value PW, the USBKey provided by the user has the cryptographic values E(F) and EK representing the user, and the user identity of the terminal device is confirmed.

5. Confirmation of Authentication Result

As shown in FIG. 4, the measurement-control application server constructs an identity authentication confirmation message according to an identity authentication result and transmits the message to the terminal device. After receiving the identity confirmation information, the terminal device uses USBKey to decouple the data to obtain the identity authentication result, and creates a session key with the measurement and control server. The confirmation process of the authentication result comprises the following steps:

a) An identity verification result parameter AUTH∈{True,False} is created; a random number R₂ and authentication time T₂ are generated; and a response message parameter is computed:

(P₁,P₂,P₃,P₄)=(R₂⊕h(V₂∥T₂),R₂^{V}^{₂} mod p,h(P₂|T₂),AUTH⊕(h(K|R₂))

b) An identity authentication confirmation message {P₁, P₃, T₂,AUTH} is created; the message is fed back to the USBKey and a session key Skey=h(K, V₂, P₂, R₁, R₂, T₁, T₂) with the terminal device is also created.

c) After receiving the confirmation information, the USBKey device inspects the timeliness of the time mark T₂, recomputes the parameter R₂=P₁⊕h(V₂∥T₂), P₂=R₂^{V}^{ₕ} mod p, \hat{P}₃=h(P₂∥T₂), and compares the parameter with P₃ in the confirmation message; \hat{P}₃=P₃ indicates that the measurement-control application server holds the secret value x and cryptographic function β(·) that represent the identity, can compute the identity authentication key K of the user, and can decouple identity evidence V₂ from the identity authentication request message; and an identity authentication decoupling result AUTH=P₄ ⊕h(K|R₂) is reliable. The session key is computed according to b).

6. Key Negotiation Based on Chebyshev Mapping Chaotic Public Key Cryptography

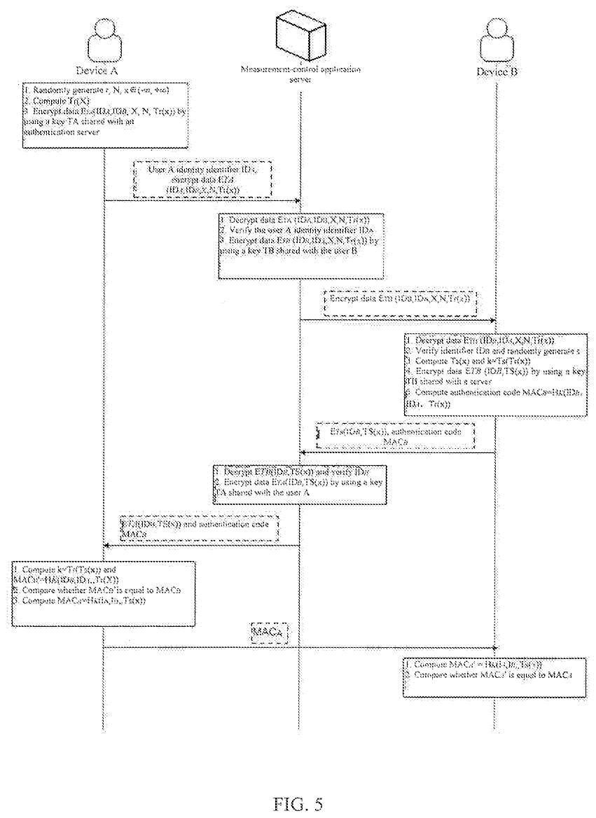

As shown in FIG. 5, two measurement and control terminal devices with confirmed valid user identity credentials after identity authentication conduct communication key negotiation by using a Chebyshev-based mapping chaotic public key cryptographic algorithm, which comprises the following steps:

a) The terminal device A firstly selects a large integer r, a large prime number N and x on a finite field, and computes Tᵣ(x), and connects an own user identity identifier ID_{A}, a recipient device identity identifier ID_{B}, x, N and Tᵣ(x), encrypts with a shared session key created between the terminal device A and the measurement-control application server, generates a ciphertext E_{TA}(ID_{A}, ID_{B}, x, N, Tᵣ(x)) and then transmits the ciphertext to the measurement-control application server.

b) After receiving the information, the measurement-control application server decrypts the data E_{TA}(ID_{A}, ID_{B}, x, N, Tᵣ(x)) by using a key shared with the terminal device A to verify whether the device A is a legal identity; if verification fails, the decryption is stopped; otherwise, the obtained information is encrypted by using the key shared with the terminal device B to obtain E_{TB}(ID_{B}, ID_{A}, x, N, Tᵣ(x)); and E_{TB}(ID_{B}, ID_{A}, x, N, Tᵣ(x)) is transmitted to the terminal device B.

c) After receiving the information, the terminal device B decrypts E_{TB}(ID_{B}, ID_{A}, x, N, Tᵣ(x)) by using the key shared with the measurement-control application server, and then randomly selects a large integer s for computing Tₛ(x); the identity identifiers ID_{B} and Tₛ(x) of the device B are connected and encrypted with the key shared with the measurement-control application server, i.e., E_{TB}(ID_{B}, Tₛ(x)). Then, k=Tₛ(Tᵣ(x)) is computed, and MAC_{B}=hₖ(ID_{B}, ID_{A}, Tᵣ(x)) is computed through Hash function by using k as a key. The device B transmits E_{TB}(ID_{B}, Tₛ(x)) and MAC_{B} to the measurement-control application server.

d) After receiving the information, the measurement-control application server decrypts E_{TB}(ID_{B}, Tₛ(x)) by using a key shared with the device B and verifies the identity of the device B. If verification fails, decryption is stopped; otherwise, the measurement-control application server encrypts ID_{B} and Tₛ(x) by using a key shared with the device A, i.e., E_{TA}(ID_{B}, Tₛ(x)). Then, E_{TA}(B, Tₛ(x)) and MAC_{B} are transmitted to the device A.

e) After receiving the information, the device A computes MAC′_{A}=hₖ(ID_{B},ID_{A},Tₛ(x)) and compares whether MAC′_{B} is equal to MAC_{B}. If not, the device A stops negotiation communication with B. Otherwise, the device A confirms that B is a true communication object and a session key shared by the devices A and B is k=Tₛ(Tₛ(x)). The device A can choose to transmit an authentication result message MAC_{A}=hₖ(ID_{A}, ID_{B},Tₛ(x)) to the device B for confirmation.

f) The device B computes a Hash function value MAC′_{A}=hₖ(ID_{A}, ID_{B}, Tₛ(x)) by using a key k, and compares whether MAC′_{A} is equal to received MAC_{A}; if not, the device B stops negotiation. Otherwise, the device A is confirmed as a true communication object; and a session key is k. MAC′_{B} and MAC_{B} represent message confirmation codes obtained by encryption by the terminal device B with the Hash function through the key k shared with the server.

1. A trusted measurement and control network authentication method based on double cryptographic values and chaotic encryption, characterized by comprising the following steps:
a control terminal and a measurement-control application server perform consistency analysis to verify the integrity of control terminal software;
the control terminal and the measurement-control application server respectively generate user identifier information by using a user cryptographic value and a measurement-control application server cryptographic value, and transmit the information by asymmetric encryption;
the control terminal generates a user identity credential; and
the measurement-control application server deduces the authenticity of the user identifier information held by a user by analyzing the user identity credential.

2. The trusted measurement and control network authentication method based on double cryptographic values and chaotic encryption according to claim 1, characterized in that the step that the control terminal and the measurement-control application server perform consistency analysis to verify the integrity of control terminal software comprises the following steps:
2a) the terminal device enables the control terminal software module to execute according to a reserved order in a mode of firstly verifying and then jumping, to enhance the integrity of the control terminal software;
2b) a software module code M is transmitted to TPM in the control terminal; SHA-1 engine in the TPM computes a code digital fingerprint PCR of the software module and stores the code digit fingerprint PCR into a platform configuration register by hash extension, i.e., PCRᵢ=SHA-1(PCRᵢ∥Pᵢ), to produce an integrity representation log SML; i indicates a digital fingerprint number and SHA-1 indicates a one-way hash function;
2c) the measurement-control application server transmits a challenge string Challenge=Nonce to start integrity verification; the control terminal signs the PCR and Nonce with a private key AIK_SK of the control terminal for an internal platform configuration register, and forms a response message Response=Sign_{AIK_SK}{PCR, Nonce}∥SML with SML; Sign_{AIK_SK} indicates that the private key AIK_SK is used for digital signature operation;
2d) the measurement-control application server verifies the digital signature by using a control terminal public key AIK_PK, compares an obtained PCR integrity representative value, i.e., digital fingerprint PCR, with a PCR integrity representative value acquired by the integrity representation log SML, and verifies the integrity of the control terminal software: if consistent, integrity verification is successful; otherwise, verification fails.

3. The trusted measurement and control network authentication method based on double cryptographic values and chaotic encryption according to claim 1, characterized in that the step that the control terminal and the measurement-control application server respectively generate user identifier information by using the user cryptographic value and the measurement-control application server cryptographic value, and transmit the information by asymmetric encryption comprises the following steps:
3a) the measurement-control application server generates user identity identification code F=[h(ID∥x)·h(PW∥UPK)^{β(κ)}]mod p by using a server cryptographic value [symbol] , a secret function β(·), an ID number provided by a user, a user public key UPK and a hash value of a user cryptographic value PW; h(·) indicates a one-way hash function; x indicates that the measurement-control application server holds a secret value that represents the identity; mod indicates modulo division;
3b) read protection encapsulation is conducted on the user identity identification code F through h(PW∥UPK) to obtain E(F):
E(F)=F⊕h(PW∥UPK)
3c) user identifier information {ID, C, h(PW∥UPK), E(F), EK, p, UN, AN, UC, . . . } composed of an encrypted and encapsulated user identity identification code E(F), a user ID, an encrypted and encapsulated identity authentication key EK, h(PW∥UPK), parameter p, user name UN, an area name AN and a user class UC is encrypted by using a public key UPK, and transmitted to USBKey device; USBKey adopts a private key SPK opposite to the UPK for decryption and saving; USBKey is transmitted and imported for the user identifier information through asymmetric encryption to create a secure channel.

4. The trusted measurement and control network authentication method based on double cryptographic values and chaotic encryption according to claim 3, characterized in that the step that the control terminal generates a user identity credential comprises the following steps:
4a) the terminal device computes an extraction parameter h(PW∥UPK) of the user cryptographic value, de-encapsulates E(F) and restores F by computing F=E(F)⊕(PW∥UPK), and conducts transformation through an identity authentication key K=β(h(x)^{h(ID)} mod p) between the USBKey and the measurement-control application server to obtain a user identity identification code V₁=F^{h(K)} mod p; h(·) indicates a one-way hash function; mod indicates modulo division; β(·) indicates a secret function; p indicates a parameter;
4b) a user random number R₁ acts on V₁ to obtain a dynamic change user identity credential V₂:
V₂=R₁^{h(V}^{₁}^{∥K)} mod p
4c) a time mark T₁ is used for converting and generating a user identity credential of timeliness;
(Q₁, Q₂, Q₃)=(V₁⊕h(K|T₁), R₁⊕h(K|T₁),{F6}h(|V₁)); [symbol] indicates a server cryptographic value;
d) a user identity authentication request (ID, Q₁, Q₂, Q₃, T₁) is finally produced, and transmitted to the measurement-control application server through a network.

5. The trusted measurement and control network authentication method based on double cryptographic values and chaotic encryption according to claim 3, characterized in that the step that the measurement-control application server deduces the authenticity of the user identifier information held by a user by analyzing the user identity credential comprises the following steps:
5a) after receiving the identity authentication request {ID, Q₁, Q₂, Q₃, T₁} transmitted by the terminal device, the measurement-control application server firstly inspects the timeliness: if T−T₁≤threshold ΔT is satisfied, the identity authentication key K=β(h(x)^{h(ID)} mod p) shared with the USBKey is computed through the cryptographic value K, the secret function β(·) and the ID number provided by the user;
5b) next, the random number R₁=Q₂ ⊕h(K∥T₁) is decoupled from Q₂ by using K and T₁; the user identity identification code V₁=Q₁ ⊕(K∥T₁) is restored from Q₁; a random user identity credential V₂=R₁^{h(V}^{₁}^{∥K)} mod p and a user identity credential \hat{Q}₃=h(V₁∥T₁) with the time mark are computed through R₁, V₁ and K;
5c) then, the identity credential \hat{Q}₃ obtained by restoring of the measurement-control application server is compared with the received identity credential Q₃; the user identification code V₁ and an expected user identity identification code PF=F^{h(K)} mod p are restored; consistence between V₁ and PF indicates that the user masters the cryptographic value PW, the USBKey provided by a terminal user has the cryptographic values E(F) and EK representing the users, and the user identity of the terminal device is confirmed.

6. The trusted measurement and control network authentication method based on double cryptographic values and chaotic encryption according to claim 5, characterized by further comprising confirming an authentication result, which comprises the following steps:
6a) the measurement-control application server creates an identity verification result parameter AUTH∈{True,False}, generates a random number R₂ and authentication time T₂ and computes a response message parameter:
(P₁,P₂,P₃,P₄)=(R₂⊕h(V₂∥T₂),R₂^{V}^{₂} mod p,h(P₂|T₂),AUTH⊕h(K|R₂));
6b) the measurement-control application server creates an identity authentication confirmation message (P₁, P₃, T₂,AUTH), feeds back the message to the USBKey and also creates a session key Skey=h(K, V₂, P₂, R₁, R₂, T₁, T₂) with the terminal device;
6c) after receiving the confirmation message, the USBKey device inspects the timeliness of the time mark T₂: recomputes the parameter R₂=P₁⊕h(V₂∥T₂), P₂=R₂^{V}^{₂} mod p, \hat{P}₃=h(P₂∥T₂) and compares the parameter with P₃ in the confirmation message; \hat{P}₃=P₃ indicates that the measurement-control application server holds the secret value x and cryptographic function β(·) that represent the identity, can compute the identity authentication key K of the user, and can decouple identity evidence V₂ from the identity authentication request message; an identity authentication decoupling result AUTH=P₄ ⊕h(K|R₂) is reliable; the session key is computed according to 6b).

7. The trusted measurement and control network authentication method based on double cryptographic values and chaotic encryption according to claim 1, characterized in that two measurement and control terminal devices with confirmed valid user identity credentials (Q₁, Q₂, Q₃) after identity authentication conduct communication key negotiation by using a chaotic public key cryptographic algorithm, which comprises the following steps:
a) the terminal device A firstly selects a large integer r, a large prime number N and x on a finite field, and computes Tᵣ(x); and connects an own user identity identifier ID_{A}, a recipient device identity identifier ID_{B}, x, N and Tᵣ(x), encrypts with a shared session key created between the terminal device A and the measurement-control application server, generates a ciphertext E_{TA}(ID_{A}, ID_{B}, x, N, Tᵣ(x)) and then transmits the ciphertext to the measurement-control application server; r and N are larger than set values;
b) after receiving the information transmitted by the terminal device A, the measurement-control application server decrypts the data E_{TA}(ID_{A}, ID_{B}, x, N, Tᵣ(x)) by using a key shared with the terminal device A to verify whether the device A is a legal identity; if verification fails, the decryption is stopped; otherwise, the obtained information is encrypted by using the key shared with the terminal device B to obtain E_{TB}(ID_{B}, ID_{A}, x, N, Tᵣ(x)); and E_{TB}(ID_{B}, ID_{A}, x, N, Tᵣ(x)) is transmitted to the terminal device B;
c) after receiving the information, the terminal device B decrypts E_{TB}(ID_{B}, ID_{A}, x, N, Tᵣ(x)) by using the key shared with the measurement-control application server, and then randomly selects a large integer s for computing Tₛ(x); the identity identifiers ID_{B} and Tₛ(x) of the terminal device B are connected and encrypted with the key shared with the measurement-control application server, i.e., E_{TB}(ID_{B},Tₛ(x)); then, k=Tₛ(Tᵣ(x)) is computed, and a message confirmation code MAC_{B}=hₖ(ID_{B}, ID_{A}, Tᵣ(x)) is computed through Hash function by using k as a key; the terminal device B transmits E_{TB}(B, Tₛ(x)) and MAC_{B} to the measurement-control application server; s is larger than a set value; hₖ indicates the Hash function; Tₛ(x) and Tᵣ(x) indicate computation expressions of the chaotic public key cryptographic algorithm;
d) after receiving the information transmitted by the terminal device B, the measurement-control application server decrypts E_{TB}(ID_{B}, Tₛ(x)) by using a key shared with the device B and verifies the identity of the device B; if verification fails, decryption is stopped; otherwise, the measurement-control application server encrypts ID_{B} and Tₛ(x) by using a key shared with the device A, i.e., E_{TA}(ID_{B},Tₛ(x)); then, E_{TA}(ID_{B},Tₛ(x)) and MAC_{B} are transmitted to the terminal device A;
e) after receiving the information transmitted by the measurement-control application server, the terminal device A computes a message confirmation code MAC′_{B}=hₖ(ID_{B}, ID_{A},Tᵣ(x)) and compares whether MAC′_{B} is equal to MAC_{B}; if not, the device A stops negotiation communication with B; otherwise, the device A confirms that B is a true communication object and a session key shared by terminal devices A and B is k=Tₛ(Tᵣ(x)); the terminal device A transmits an authentication result message MAC_{A}=hₖ(ID_{A}, ID_{B}, Tₛ(x)) to the terminal device B for confirmation;
f) the terminal device B computes a Hash function value MAC′_{A}=hₖ(ID_{A}, ID_{B}, Tₛ(x)) by using a key k, and compares whether MAC′_{A} is equal to received MAC_{A}; if not, the terminal device B stops negotiation; otherwise, the terminal device A is confirmed as a true communication object; and a session key is k.
